(19) United States
(12) Patent Application Publication
(10) Pub. No.: US 2024/0180307 A1
(43) Pub. Date: Jun. 6, 2024

(54) PORTABLE ELECTRONIC DEVICE COVER HAVING FLEXIBLE AWNINGS

(71) Applicant: SHEINER ENGINEERING & DESIGN, LLC, Whitestone, NY (US)

(72) Inventor: Brandon Michael SHEINER, Whitestone, NY (US)

(21) Appl. No.: 18/531,593

(22) Filed: Dec. 6, 2023

Related U.S. Application Data
(60) Provisional application No. 63/386,311, filed on Dec. 6, 2022.

(51) Int. Cl. A45C 11/00; A45C 15/00

(52) U.S. Cl. CPC A45C 11/00; A45C 15/00; A45C 2011/002; A45C 2011/003

(57) ABSTRACT

Provided are covers for portable electronic devices comprising a case body having a planar back and a sidewall, as well as one or more awnings disposed along the case body, wherein the awnings extend from and are movably engaged to the case body. Related methods of use are further provided.

### BACKGROUND

Portable electronic devices such as tablets and mobile phones have become essential tools for everyday life. Many people use their phone as not only their primary means of communication with others, but also as a source of entertainment and information. Since their inception, mobile phones have evolved and improved to have increased computing power, longer battery life, and a variety of increasingly capable wireless technology options for sending and receiving data. As a result, the full spectrum of a mobile phone's applications may be used anywhere that it can be carried.

A basic limitation of mobile phones is that the temperature of the equipment must be kept within an acceptable range. If the equipment is not kept below the acceptable maximum temperature limit, the equipment can overheat and result in a variety of performance issues. For example, if left unchecked overheating may cause permanent irreparable damage to the equipment's hardware. The risk of overheating is amplified outdoors, especially when using a mobile phone for prolonged periods of time with exposure to the sun. Extended use of mobile phones outdoors therefore must be limited to shaded areas, which may not be available, depending on location. This limitation creates a barrier to enjoying the outdoors and, in effect, limits the portability of mobile phones.

Additionally, when mobile phones are used outdoors, sunlight reflecting from the screen of the phone can produce a glare, prompting a user to increase brightness of the screen. This, however, exacerbates the potential of overheating, while also speeding the battery drain of the device. Without substantially altering the brightness of the screen, the contents of the screen become difficult to discern and may also lead to eye strain and fatigue.

While there are several screen protectors advertised to be “anti-glare,” these anti-glare screen protectors do not protect the phone from the heat of direct sunlight and do not always work very well at preventing glare from most viewing angles. Many of the anti-glare and shade covers of the prior art are bulky and not easily removed from the phone. Some are intended to be permanently affixed, which makes holding and pocketing the phone more difficult.

There is thus a need in the art to more freely use a mobile phone outdoors without necessitating choice between being confined to a shaded area or the risk of overheating the device. There is further need for a product that allows a user to shield their phone from direct sunlight to prevent overheating and eliminate screen glare during use, while remaining lightweight, portable, quickly removeable and easily manufactured.

### SUMMARY

Accordingly, provided herein are covers for portable electronic devices, e.g., mobile phones, smartphones or tablets, which allow users the ability of more freely using their electronics outdoors without needing to choose between shaded area or sacrificing battery life or risking overheating their device. Further provided herein are products capable of allowing a user to shield their phone from direct sunlight to prevent overheating and eliminate screen glare during use, while remaining lightweight, portable, and easily manufactured. The covers provided herein may further be made from a thermally insulative material to provide protection from environmental heat as well as heat caused by exposure to ultraviolet radiation.

In a first aspect, the present disclosure is directed to a cover [Cover 1] for a portable electronic device comprising:
a case body having a planar back defined by a sidewall; and
one or more awnings disposed along the case body such that the one or more awnings collectively and continuously span around the entire perimeter of the case body, wherein the one or more awnings extend from and are movably engaged to the case body,
wherein the portable electronic device is receivable within case body.

In some embodiments, Cover 1 is further defined as follows.
1.1 Cover 1, wherein the one or more awnings comprises a plurality of awnings.
1.2 Cover 1 or 1.1, wherein each of the one or more awnings are comprised of a shape-retaining flexible material.
1.3 Any of the preceding Covers, wherein each of the one or more awnings comprise a planar surface which extends proximally from the case body.
1.4 Any of the preceding Covers, wherein the cover comprises at least two awnings.
1.5 Any of the preceding Covers, wherein the cover comprises two, three, or four awnings.
1.6 Any of the preceding Covers, wherein the cover comprises four awnings.
1.7 Any of the preceding Covers, wherein the planar surface of each of the awnings curve in correspondence with one or more corners of the case body (e.g., while in a shading configuration).
1.8 Any of the preceding Covers, wherein each awning is positioned at a corner of the case body, such that each awning spans across two adjacent sides of the case body.
1.9 Any of the preceding Covers, wherein each awning is positioned at a corner of the case body and spans between a longitudinal side of the sidewall and an adjacently positioned latitudinal side of the sidewall.
1.10 Any of the preceding Covers, wherein each awning is positioned at a corner of the case body and spans between a midpoint of a longitudinal side of the sidewall and a midpoint of an adjacently positioned latitudinal side of the sidewall.
1.11 Any of the preceding Covers, wherein each awning is disposed with the case body at a distal end of each respective awning, such that said distal end extends continuously along the perimeter between two adjacent sides of the case body.
1.12 Any of the preceding Covers, wherein each awning is disposed with the case body at a distal end of each respective awning, such that said distal end extends continuously between a longitudinal side of the sidewall and an adjacently positioned latitudinal side of the sidewall.
1.13 Any of the preceding Covers, wherein each awning is disposed with the case body at a distal end of each respective awning, such that said distal end between a midpoint of a longitudinal side of the sidewall and a midpoint of an adjacently positioned latitudinal side of the sidewall.
1.14 Any of the preceding Covers, wherein each awning comprises a proximal end extending away from the distal end and defines a curved surface corresponding to a portion of the perimeter of the case body to which the respective awning is disposed.
1.15 Any of the preceding Covers, wherein the cover comprises two awnings positioned adjacent one another and wherein each of the two awnings extends along at least half of the perimeter of the case body.
1.16 Any of the preceding Covers, wherein the cover is movable between a shading configuration in which the awnings extend from a distal end disposed with the case body to a proximal end away from the case body and a compact configuration in which the awnings are folded back along a back surface of the case body.
1.17 Any of the preceding Covers, comprising a first awning positioned at a first corner of the case body and a second awning positioned at a second corner of the case body, wherein the first corner and the second corner are adjacent one another, and the first awning and the second awning are arranged to extend proximally from the case body so as to cast a continuous shadow over the electronic device while in the shading configuration.
1.18 Any of the preceding Covers, comprising a first awning positioned at a first corner of the case body, a second awning positioned at a second corner of the case body, a third awning positioned at a third corner of the case body, and a fourth awning positioned at a fourth corner of the case body, and wherein the first, second, third and fourth awnings are arranged to extend proximally from the case body and cast a continuous shadow over the electronic device while in the shading configuration.
1.19 Any of the preceding Covers, wherein each of the plurality of awnings comprises a folding region.
1.20 Any of the preceding Covers, wherein one or more of the awnings are terminally affixed to the case body.
1.21 Any of the preceding Covers, wherein one or more of the awnings are removeable from the case body.
1.22 Any of the preceding Covers, wherein each member of the plurality of awnings is monolithic with the case body.
1.23 Any of the preceding Covers, wherein the back is sized to receive a mobile electronic device.
1.24 Any of the preceding Covers, wherein the sidewall defines a perimeter around the back conforming substantially to the shape of a mobile electronic device (e.g., a cell phone or a tablet or a portable gaming device).
1.25 Any of the preceding Covers, wherein the back and the sidewall are resiliently connected to one another.
1.26 Any of the preceding Covers, wherein the back and the sidewall are monolithically formed.
1.27 Any of the preceding Covers, wherein the case body and/or the one or more awnings are made of a thermally insulative material.
1.28 Any of the preceding Covers, wherein the back, the sidewall, and/or the one or more awnings are comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof.
1.29 Any of the preceding Covers, wherein the back is comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof.
1.30 Any of the preceding Covers, wherein the back is comprised entirely or partially of silicone.
1.31 Any of the preceding Covers, wherein the sidewall is comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof.
1.32 Any of the preceding Covers, wherein the sidewall is comprised entirely or partially of silicone.
1.33 Any of the preceding Covers, wherein the one or more awnings is comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof.
1.34 Any of the preceding Covers, wherein the one or more awnings is comprised entirely or partially of silicone.
1.35 Any of the preceding Covers, wherein the case body is flexible to facilitate installation and removal of a mobile electronic device.
1.36 Any of the preceding Covers, wherein the sidewall is sized to removably receive a mobile electronic device (e.g., a cell phone or tablet).
1.37 Any of the preceding Covers, wherein the sidewall is elastic and/or deflectable along a plane parallel and/or transverse to the planar back to facilitate receiving and removing an electronic device (e.g., a cell phone or tablet).
1.38 Any of the preceding Covers, wherein the sidewall includes at least one detent or gap to correspond with buttons located on a mobile electronic device.
1.39 Any of the preceding Covers, wherein the sidewall includes an opening to allow passage of a peripheral wire and/or a charge cord.
1.40 Any of the preceding Covers, wherein the back comprises an aperture corresponding to the position of a camera on a mobile electronic device.
1.41 The preceding Cover, wherein the aperture comprises a shape defined by a polygonal or round perimeter.
1.42 The preceding Cover, wherein the aperture comprises a shape defined by a substantially quadrilateral perimeter.
1.43 Either of the preceding Covers, wherein the aperture is sized and positioned to fit over a camera on a variety of similarly sized electronic devices (e.g., cell phones or tablets).
1.44 Any of the preceding Covers, further comprising a flap sized to be received within and/or cover over the perimeter of the aperture.
1.45 Any of the preceding Covers, wherein the flap includes a finger tab to facilitate user-initiated movement into and out of the aperture.
1.46 Any of the preceding Covers, wherein the flap is removeable from the aperture.
1.47 Any of the preceding Covers, wherein the flap is attached to the case body and is hingedly moveable about an axis defined by the point of attachment.
1.48 The preceding Cover, wherein the flap includes an attachment member which fits into a receptacle on a rear surface of the back, such that upon moving the flap from a closed position (i.e., received within the opening) to an open position, the attachment member engages the receptacle to maintain the flap in a closed position.
1.49 Any of the preceding Covers, wherein the flap comprises an edge sized to be received within a ridge defined along the perimeter of the opening such that the flap remains fixedly attached to the case body absent a pulling force.
1.50 Any of the preceding Covers, wherein the case body is sized to receive an electronic device containing a screen (e.g., a cellular phone or a tablet) within the space defined by the sidewalls.
1.51 Any of the preceding Covers, wherein the electronic device is one or more of a mobile phone (i.e., a smartphone), a tablet, a portable gaming device, or a monitor.
1.52 Any of the preceding Covers, wherein the electronic device is a tablet.
1.53 Any of the preceding Covers, wherein the electronic device is a mobile phone (i.e., a smartphone).
1.54 Any of the preceding Covers, wherein the electronic device is a portable gaming device.

In a second aspect, the present disclosure is directed to a kit [Kit 1] for a covering system for a portable electronic device comprising:
at least one awning which is attachable to a portable electronic device or a cover for said portable electronic device,
   wherein each of the at least one awning includes an adhesive surface to allow for disposal along a surface (e.g., a rear, side, top or bottom surface) of the portable electronic device or the cover for said portable electronic device, and
   wherein once attached to the electronic device or the cover for said portable electronic device the one or more awnings extend from and are movably engaged to the case body.
1.1 Kit 1, wherein the kit comprises a plurality of awnings.
1.2 Kit 1 or 1.1, wherein each of the awnings are comprised of a shape-retaining flexible material.
1.3 Any of the preceding Kits, wherein each of the one or more awnings comprise a planar surface which extends proximally from the plane defined by the adhesive surface.
1.4 Any of the preceding Kits, wherein the kit comprises at least two awnings.
1.5 Any of the preceding Kits, wherein the kit comprises two, three, or four awnings.
1.6 Any of the preceding Kits, wherein the kit comprises four awnings.
1.7 Any of the preceding Kits, wherein the planar surface of each of the awnings curve in correspondence with one or more corners on a portable electronic device or a cover for said portable electronic device.
1.8 Any of the preceding Kits, wherein the adhesive surface of each awning is situated at a distal end of each respective awning.
1.9 Any of the preceding Kits, wherein each awning comprises a proximal end extending away from the distal end and defines a curved surface corresponding to a portion of the perimeter of the case body to which the respective awning is disposed.
1.10 Any of the preceding Kits, wherein the awnings are flexible such that when attached to a portable electronic device or a cover for said portable electronic device, extend from a distal end disposed with the portable electronic device or cover for said portable electronic device to a proximal end, and is moveable to a compact configuration in which the awnings are folded back along the portable electronic device or cover for said portable electronic device.
1.11 Any of the preceding Kits, wherein each of the plurality of awnings comprises a folding region.
1.12 Any of the preceding Covers, wherein the one or more awnings is comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof.
1.13 Any of the preceding Covers, wherein the one or more awnings is comprised entirely or partially of silicone.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

Further aspects, features, benefits, and advantages of the embodiments will be apparent with regard to the following description, appended claims and accompanying drawings where:

FIG. 1 illustrates a front perspective view of components of a cover in accordance with the present disclosure. The cover is shown in a shading configuration.

FIG. 2 illustrates a front perspective view of components of a cover in accordance with the present disclosure. The cover is shown in a compact configuration.

FIG. 3 illustrates a front perspective view of components of a cover in accordance with the present disclosure. The cover is shown in a partial shading configuration for use of an electronic device in a landscape orientation.

FIG. 4 illustrates a front perspective view of components of a cover in accordance with the present disclosure. The cover is shown in a partial shading configuration for use of an electronic device in a portrait orientation.

FIG. 5 illustrates a rear view of components of a cover in accordance with the present disclosure. The cover is shown in a partial shading configuration for use of an electronic device in a portrait orientation.

FIG. 6 illustrates a rear view of components of a cover in accordance with the present disclosure. The cover is shown in a compact configuration.

FIG. 7 illustrates a rear perspective view components of a cover in accordance with the present disclosure. The cover is shown in a shading configuration.

It is to be understood that the figures may not be to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

For the purposes of this specification and appended claims, unless otherwise indicated, all numbers used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present application. At the very least, and not as an attempt to limit the application of the doctrine of equivalents to the scope of the claims, each numerical parameter should at least be construed in light of ordinary rounding techniques.

It is noted that, as used in this specification and the appended claims, the singular forms “a,” “an,” and “the” include plural referents unless expressly and unequivocally limited to one referent. Thus, for example, reference to “a cover” may include one, two, three or more covers.

It is also understood that all spatial references, such as, for example, horizontal, vertical, top, base, upper, lower, bottom, left and right, are for illustrative purposes only and can be varied within the scope of the disclosure.

Mobile or otherwise portable technology has advanced considerably in recent years, but with these advances have come a new set of problems. For example, a smartphone can offer near limitless access to information and communication with others from virtually anywhere. A smartphone's use is primarily limited by its battery life. One of the foremost drains on a smartphone's battery derives from running the screen, especially at high brightness. When in direct sunlight, a user typically must increase the brightness of the screen to compensate for external light. Not only does this drain the battery of the smartphone faster, it also causes the smartphone to heat. If left unchecked for long enough, the smartphone could overheat. This issue is exacerbated by the heat caused by ultraviolet radiation in sunlight. Even when not in use, an electronic device exposed to direct sunlight may be subject to overheating solely from absorbed energy in the form of heat.

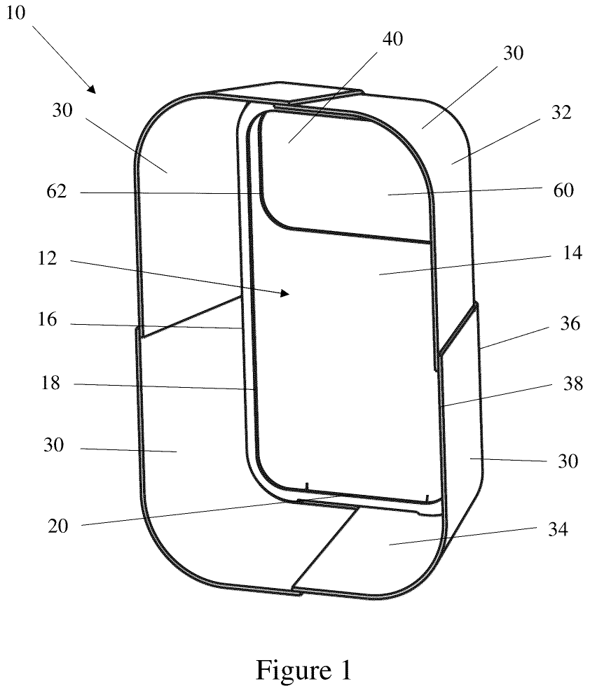

Thus, there exists a need for a simple and effective apparatus which solves each of these problems. The following discussion includes a description of a cover 10 for a portable electronic device such as a smartphone, tablet, or portable gaming system and provide shade for use under sunlight. Alternate embodiments are also disclosed. Reference is made in detail to the exemplary embodiments of the present disclosure, which are illustrated in the accompanying figures. Turning to FIGS. 1-7, there are illustrated components of a cover 10 for a portable electronic device.

Disclosed herein is a cover 10, which comprises a case body 12 having a planar back 14 defined by a sidewall 16, and one or more awnings 30 disposed along case body 12, wherein awnings 30 extend from and are movably engaged to case body 12. Cover 10 is sized and configured such that a portable electronic device is receivable within case body 12. Cover 10 is designed to be transformable between a shading configuration to facilitate use of an electronic device (e.g., a cell phone or tablet) in a sunny environment, and a compact configuration to facilitate storage of the electronic device, for example in a user's pocket, backpack, or purse. When used to envelop an electronic device such as a cell phone or a tablet, cover 10 provides shade from UV rays or any bright environment, and also imparts qualities of thermal resistance and shock resistance.

According to the present disclosure, case body 12 comprises a planar back 14 surrounded by a sidewall 16. The shape and size of back 14 is defined by the perimeter 22 of sidewall 16. In various embodiments, back 14 is substantially quadrilateral in shape, e.g., rectangular. However, it is envisioned that back 14 may take the form of a variety of shapes, including polygonal, circular or irregularly shaped. In various embodiments back 14 conforms to the shape of an electronic device (e.g., a cell phone, tablet, screen, or portable gaming device). Back 14 may be elastic, pliable, and/or flexible in a plane parallel or transverse to the plane of back 14 to facilitate case of installation and/or removal from the electronic device. In various embodiments, back 14 may further be deformable or compressible to impart qualities of shock absorbance. In certain embodiments, back 14 is comprised of an assembly of layered materials to impart a combination of qualities to case body 12. For example, back 14 may include a layer to impart structural rigidity, another layer to impart compressibility, and/or a layer to impart elasticity to case body 12. Various combinations of layered materials are envisioned to allow for versatility of case body 12.

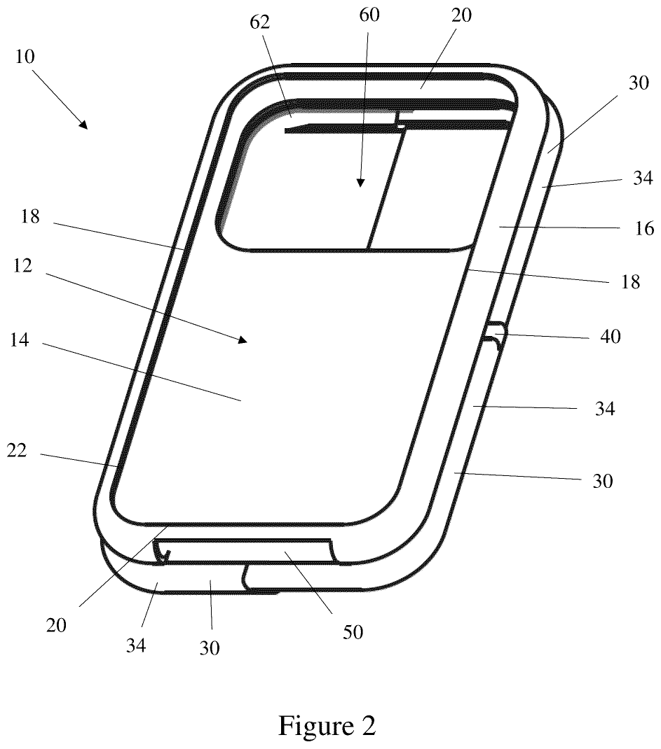

As shown in the Figures, Sidewall 16 extends around back 14 and is defined by two oppositely positioned longitudinal sides 18 and two oppositely positioned latitudinal sides 20, which extend transversely between longitudinal sides 18. As shown, for example, in FIG. 2 longitudinal sides 18 and latitudinal sides 20 are connected by corners and define a continuous perimeter 22. The corners bridging longitudinal sides 18 and latitudinal sides may be sharp or rounded, and preferably correspond to the shape of an electronic device. In various embodiments, however, perimeter 22 of sidewall 16 can take any number of shapes, including polygonal, circular or irregularly shaped. In preferred embodiments, perimeter 22 is a quadrilateral, e.g., in the form of a rectangle. The size and dimensions of perimeter 22 may optimally be defined by the size of a desired electronic device (e.g., a cell phone, tablet, screen, or portable gaming device).

Sidewall 16 is configured to wrap securely around the perimeter of an electronic device. In various embodiments, sidewall 16 has a concave inner surface which conforms to the curvature of an edge of an electronic device. The presence of the concave surface maximizes contact between sidewall 16 and the edge of the electronic device to facilitate a comprehensively tight fit between the electronic device and sidewall 16. The inner concave surface of sidewall 16 is therefore configured to prevent sliding or movement of the electronic device while received within case body 12. In various embodiments, this concave surface may be made from or coated with a material that imparts gripping qualities. Examples of materials useful for this purpose include rubber and silicone.

In various embodiments, sidewall 16 is connected to back 14 around the entire perimeter of back 14. That is, back 14 and sidewall 16 form a continuous surface for engaging the electronic device. In certain embodiments, sidewall 16 is monolithically formed with back 14. That is, in some embodiments, sidewall 16 forms a unitary structure with back 14 and is non-removable therefrom.

In some embodiments, sidewall 16 may be made from complementary shell pieces that join to enclose the portable electronic device within. For example, sidewall 16 may include a front shell and a rear shell, both of which comprise complementary perimeters corresponding with the shape of the electronic device. The front shell is sized to fit over a front face of the electronic device, while the rear shell fits over a rear face of the electronic device. The front shell and rear shell may be configured to resiliently attach to one another, e.g., by latches or snaps positioned at one or more points along the perimeter of the shells. In some embodiments, the rear shell is attached or attachable to back 14, and in other embodiments, the rear shell is monolithic with back 14.

One or both of back 14 and sidewall 16 may be comprised of a thermally insulative material to protect the electronic device from heat gain (e.g., via direct exposure to UV light) from the ambient environment. For example, back 14 and/or sidewall 16 may be comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof. In preferred embodiments, the back 14 is made from a material that provides thermally insulative properties and is also flexible, while the sidewall 16 is made from an elastic material which is also deformable to provide shock resistance to the electronic device. In some embodiments, both back 14 and sidewall 16 are made from a material that provides thermally insulative properties and is also flexible. In some embodiments, both back 14 and sidewall 16 are made from an elastic material which is also deformable to provide shock resistance to the electronic device. In various embodiments, one or both of back 14 and sidewall 16 is made from a material which imparts a gripping quality to the surface of case body 12 (e.g., silicone).

In certain embodiments, sidewalls 16 further include one or more detents and/or gaps aligning with one or more side buttons on an electronic device. For example, a cell phone commonly contains at least one volume button (e.g., a volume rocker button) and a screen power button. In order to allow for access to such buttons while cover 10 is engaged with the electronic device, sidewall 16 may include detents sized and positioned to fit over one or more such buttons on an electronic device. The detents are envisioned to be sufficiently deflectable to allow a user to press the button by applying pressure on the detent. In certain embodiments, sidewall 16 does not comprise a detent and/or gap, but is made from a material which is sufficiently deflectable to allow a user to press a button along the side of the electronic device regardless of its location. For example, one particularly suitable material to serve this purpose is silicone. In other embodiments, sidewall 16 may be made from a deflectable woven material, e.g., a cloth such as nylon, which may possess also clastic properties.

According to the present disclosure, cover 10 further comprises at least one awning 30 to provide shade to an electronic device held within case body 12. In various embodiments, cover 10 has one awning which extends around the perimeter of case body 12. In other embodiments, cover 10 may have two awnings 30 extending from case body 12. In such embodiments, these two awnings 30 are positioned adjacent to one another (e.g., oppositely positioned but overlapping) and each extend over at least half of the perimeter of case body 12. For example, the first of the two awnings may extend along a top hemisphere of case body 12 (e.g., beginning at a midway point on a first longitudinal side 18, running along the length of a top latitudinal side 20, and terminating at a midway point on a longitudinal side 18 oppositely positioned from the beginning point), while the second of the two awnings may extend along a bottom hemisphere of case body 12 (i.e., beginning at a midway point on a first longitudinal side 18, running along the length of a bottom latitudinal side 20, and terminating at a midway point on a longitudinal side 18 oppositely positioned from the beginning point). Cover 10 may alternatively comprise a first awning which extends along a side hemisphere of case body 12 (e.g., beginning at a midway point on the top latitudinal side 18, running along the length of a longitudinal side 20, and terminating at a midway point on the bottom latitudinal side 18 oppositely positioned from the beginning point), while the second of the two awnings may be positioned along a side hemisphere of case body 12 mirroring the first awning (i.e., beginning at a midway point on a second longitudinal side 18, running along the length of a bottom latitudinal side 20, and terminating at a midway point on a longitudinal side 18 oppositely positioned from the beginning point).

In the embodiments shown in the Figures, e.g., FIG. 1, case body 12 comprises four awnings 30 positioned in quadrants around case body 12. That is, as shown in the figures, each awning 30 is positioned at a corner of case body 12, such that each awning 12 spans across two adjacent sides of case body 12. For example, in some embodiments, each awning is positioned at a corner of the case body and spans across two adjacent sides of sidewall 16. Each awning may thus be positioned at a corner of the case body and span between a longitudinal side of the sidewall and an adjacently positioned latitudinal side of the sidewall (e.g., between a midpoint of a longitudinal side of the sidewall and a midpoint of an adjacently positioned latitudinal side of the sidewall).

Each awning 30 comprises a height, which, when in a shading configuration, extends away from case body 12 between a distal end 36 and a proximal end 38. Each awning 30 includes an outer surface 32 and an inner surface 34. As shown for example in FIG. 1, outer surface 32 faces generally away from perimeter 22 when cover 10 is in a shading configuration (i.e., when awnings 30 are extended), while inner surface 34 faces generally toward an opposing side of sidewall 16 or an electronic device secured therein.

In the transverse plane extending proximally from case body 12, awnings 30 comprise a generally planar shape when in a shading configuration. In a frontal plane relative to the plane of back 14, awnings 30 comprise an overall shape corresponding with that of perimeter 22 of case body 12. That is, each individual awning 30 will have a shape pertaining to the portion of case body 12 from which it extends. For example, as shown in FIGS. 1-7, when all four awnings 30 are in a shading configuration, discussed below, the shape formed by the four awnings when viewed in the frontal plane will be substantially the same shape as perimeter 22. Each of the four awnings 30 accounts for about a fourth of the overall perimeter. Awnings 30 are each pitched at an angle away from case body 12 to allow for a widened range of viewing angles for a user when an electronic device is held within cover 10.

However, in other embodiments, the awnings 30 may comprise a shape conducive to shading, such as having a flared configuration from distal end 36 to proximal end 38. Awnings 30 may alternatively have an angled shape when viewed in the transverse plane relative to the plane of back 14, such that awnings 30 extend at an angle away from case body 12 to maximize a user's viewing angle of the electronic device, followed by a unitary bend or crease to an angle that is substantially perpendicular relative to the plane of back 14.

Awnings 30 are each individually disposed with case body 12 along sidewall 16 around perimeter 22. Specifically, each awning 30 is connected to the case body at distal end 36 of each respective awning 30, such that distal end 36 extends continuously along the perimeter 22 between two adjacent sides (e.g., a longitudinal side 18 and a latitudinal side 20, e.g., between a midpoint of a longitudinal side 18 and a latitudinal side 20) of case body 12. In certain embodiments, each awning 30 is permanently affixed to case body 12. For example, awnings 30 may be sewn, glued, fused or otherwise terminally or resiliently disposed with case body 12 for a permanent or semi-permanent connection. In other embodiments, awning 30 may be removably attached to case body 12, e.g., along sidewall 16 or back 14. In such embodiments, awnings 30 may be connected to case body with a reusable adhesive, hook and loop (e.g., Velcro), snaps, fasteners or other suitable means. In a preferred embodiment, awnings 30 are monolithically formed with case body 30.

In order to allow awnings 30 to maintain posture while in a shading configuration, each of awnings 30 are preferably made from a shape-retaining flexible material. In various embodiments, awnings 30 are opaque or semi-opaque to maximize shading effect while in the shading configuration.

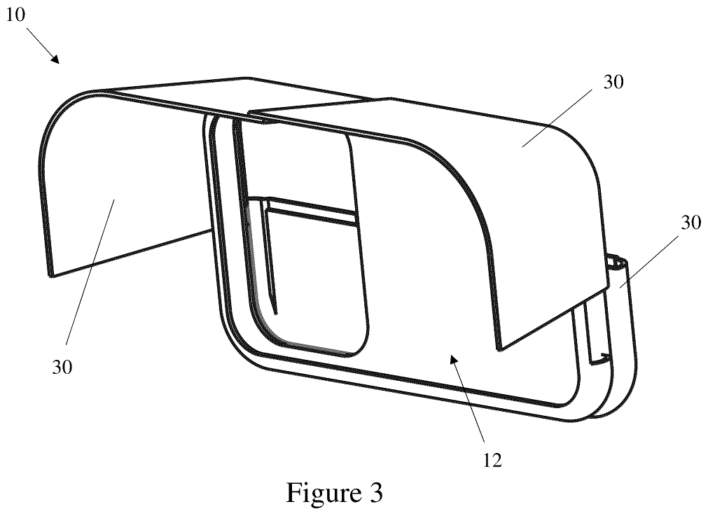

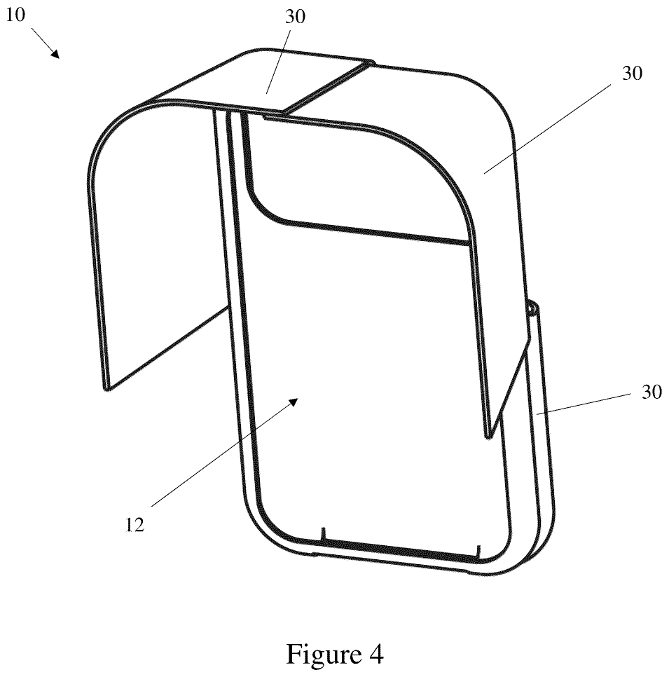

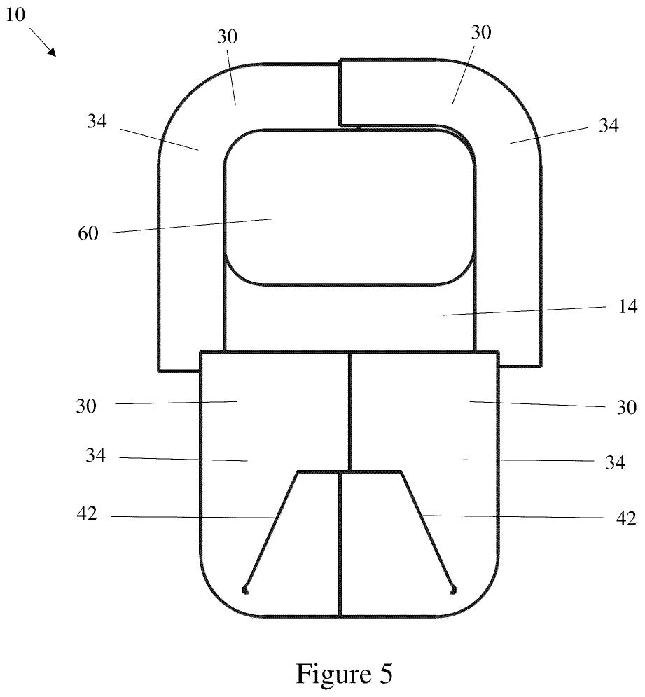

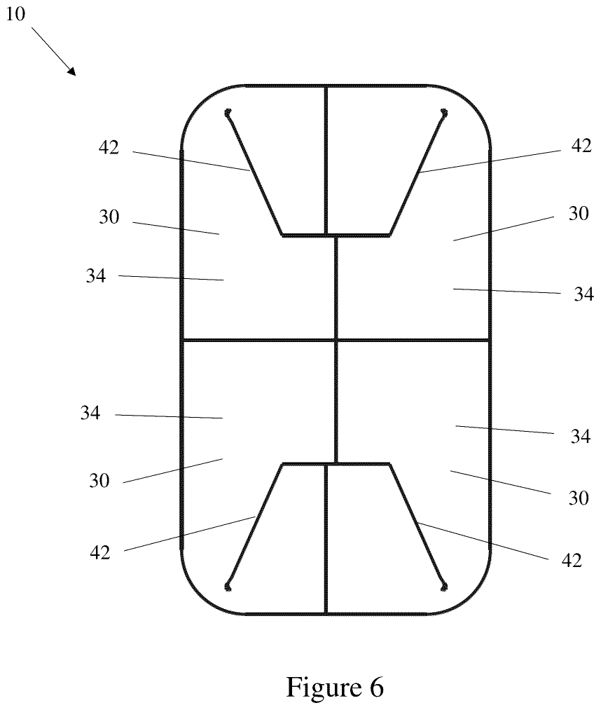

Awnings 30 as shown herein are movable between a shading configuration in which the awnings 30 extend from distal end 36 disposed with case body 12 to a proximal end 38 away from case body 12 and a compact configuration in which awnings 30 are folded back along a back surface of the case body 12 (e.g., along a back surface of back 14). For example, as shown in FIG. 1, each awning 30 retains its shape after being moved into the shading configuration such that awnings 30 form a continuous surface extending proximally from case body 12. As shown in FIGS. 2 and 6, awnings 30 are further capable of maintaining their shape while in a compact configuration. While in the compact configuration, awnings 30 are folded back so that outer surface 32 of each awning 30 lies against back 14 of case body 12. Various hybrid configurations having some awnings 30 in the shading configuration and some in the compact configuration are also possible depending on the needs of a user. For example, FIG. 3 shows cover 10 in which two awnings 30 are in the shading configuration, while the remaining two awnings 30 are in the compact configuration. According to FIG. 3, awnings 30 are positioned to facilitate use of an electronic device (e.g., a cell phone) in a landscape orientation. FIGS. 4 and 5 show cover 10 in which two awnings 30 are in the shading configuration and the remaining awnings are in the compact configuration for use of an electronic device (e.g., a cell phone) in a portrait orientation.

In various embodiments, awnings 30 are made from a material with limited compressibility. Thus, in such embodiments, awnings 30 include a folding region 42 to allow awnings 30 to assume a flattened shape against back 14 of case body 12. As shown for example in FIG. 5 or 6, folding region 42 allows awning 30 to partially fold over itself to form overlapping flaps to give awning 30 an overall flat presentation while in the compact configuration. In some embodiments, folding region 42 includes a partially weakened section, such as a crease or a set of creases, to define the path of folding.

Cover 10 comprises a plurality of awnings 30 which are arranged in an array around the perimeter of case body 12. In various embodiments, cover 10 includes at least two awnings 30. In preferred embodiments, cover 10 includes four awnings 30, as exemplified in the figures. The plurality of awnings 30 are arrayed such that adjacent awnings comprise an overlap portion 40, as shown for example in FIGS. 1 and 2, to ensure a complete shade surrounding the perimeter of case body 12. For clarity, the overlap portion 40 is the section of adjacent awnings 30 in which the outer surface 32 of a first awning 30 contacts the inner surface 34 of a second awning 30.

In various embodiments, cover 10 further comprises a sidewall opening 50 to allow passage of a peripheral cable and/or a charge cord for an electronic device secured within cover 10. In various embodiments, sidewall opening 50 is positioned on a portion of sidewall 16 that aligns with an input location on an electronic device. In some embodiments, sidewall opening 50 is disposed along a latitudinal side 20. As shown for example in FIG. 2, sidewall opening 50 is disposed along the bottom latitudinal side 20 (relative to the electronic device secured within case body 12) to correspond with a common location of charge and auxiliary ports on electronic devices such as cell phones and tablets. However, it is envisioned that sidewall opening 50 could be positioned along any of the longitudinal walls 18 or latitudinal walls 20 to accommodate the locations of cable input ports in a variety of electronic devices. Some such devices, including monitors or portable game devices may have multiple inputs located on different sides of the device. Thus, in some embodiments, cover 10 comprises more than one sidewall openings 50.

In some embodiments, cover 10 further comprises an aperture 60 positioned on the planar surface of back 14, which is sized to allow an unobstructed view through case body 12 for a camera positioned within the confines of perimeter 62 of aperture 60. Aperture 60 may be positioned toward an end (i.e., toward a latitudinal side 20) of back 14, and is sized to allow for a variety of camera positions on an electronic device, such that when the electronic device is held in place by sidewalls 16, the camera is unobstructed while cover 10 is in a shading configuration, as shown for example in FIGS. 1, 4 and 5. Aperture 60 may become obstructed at least by awnings 30 when cover 10 is in the compact configuration, as shown in FIGS. 2 and 3. While shown in a certain shape, perimeter 62 may define any shape, such as a circle, oval, square, triangle, other polygonal shapes, or irregular shapes.

In various embodiments, cover 10 further comprises a flap 70 sized to cover aperture 60 both during use and when out of use. Flap 70 generally has a shape that conforms to the shape of perimeter 62. Thus, in embodiments where the shape of the aperture 60 conforms is polygonal (e.g., square or rectangular), flap 70 will comprise a corresponding polygonal shape as well. Similarly, in embodiments where the aperture 60 comprises other shapes such as circular, polygonal, or irregular, flap 70 will comprise a shape as such. Flap 70 can also be a different shape from opening 60, so long as flap 70 sufficiently covers the entirety of opening 60 when the flap is down.

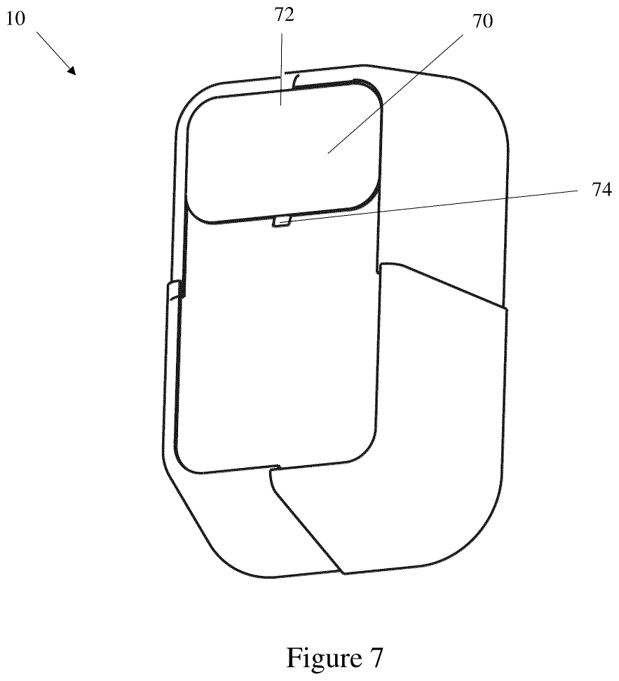

Flap 70 is positioned on a portion of the surface of back 14 which comprising aperture 60 such that the perimeter of flap 70 completely covers aperture 60. In certain embodiments, flap 70 is attached to back 14 adjacent to aperture 60 at one end. For example, flap 70 may be terminally affixed to back 14 along hinge 72. As shown in FIG. 7, flap 70 may be attached at hinge 72 located at a top side of flap 70, while the other sides of flap 70 are not attached to back 14. That is, hinge 72 of flap 70 may be permanently affixed to back 14, while the remaining sides of flap 70 may only be temporarily attachable to back 14 along the perimeter 62 of aperture 60. By way of example, the bottom end of flap 70 (i.e., oppositely positioned from hinge 72) may be attached by use of an attachment member such as magnet, clasp, Velcro or similar fabric, hook and loop, adhesive or other such means of attachment known in the art, to a corresponding receptacle on a rear surface of back 14. In a preferred embodiment, flap 70 is sized such that it snaps into place or is set in place by friction fit within the confines of aperture 60.

In various embodiments, flap 70 further comprises a pull tab 74 to aid a user in removal or opening of flap 70 from a sealed position. Tab 74 is positioned at an end opposite from hinge 72. Tab 74 may be made from the same material as flap 70 or may alternatively be made from a flexible but resilient material, such as cloth. In some embodiments, flap 70 is comprised of a thermally insulative material which is rigid to allow for a user to easily engage and disengage it from aperture 60.

In various embodiments, any of the components of cover 10 as described herein may be made from one or several thermally insulative materials. For example, any of the case body 12 (i.e., back 14 or sidewall 16), awnings 30 and/or flap 70 may be made from, but not limited to, any of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof. The components as discussed may be comprised entirely or partially of these materials. In some embodiments, the back is comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof. In some embodiments, the sidewall is comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof. In some embodiments, one or more of the plurality of awnings is comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof. In preferred embodiments, any one of the components of Cover 10 (e.g., back 14, sidewall 16, awnings 30 and/or flap 70) is comprised entirely or partially of silicone or composites thereof.

In use, cover 10 may be moved between a shading configuration and a compact configuration. While in the shading configuration, the awnings 30 extend from a distal end 36 disposed with the case body 12 to a proximal end 38 away from the case body 12 (see FIGS. 1, 3-5 and 7). While in the compact configuration, awnings 30 are folded back along a surface of the case body 12 such that the outer surface 32 of awnings 30 contacts planar back 14 of case body 12 (see FIGS. 2-6). To begin use, a user inserts an electronic device into case body 12 such that the device is held in place by back 14 and sidewalls 16. To do so, case body 12 may be deflected or sidewall 16 may be stretched until the electronic device is flush against back 14 and is secured by sidewalls 16 around its edges. In alternative embodiments, sidewall 16 may be separated into constituent front and rear shells to allow the electronic device to be enclosed within. Once the electronic device is in place, the front shell is re-attached to the rear shell. Starting from a compact configuration, awnings 30 are individually folded away from case body 12 and brought into the shading configuration. Awnings are shaped and comprised of a material that allows them to retain their shape while in the shading configuration. A user may choose to open only some of the awnings 30, e.g., as shown in FIGS. 3-5 to facilitate use of a phone in either the landscape or portrait orientation. Upon completion of use, a user may fold awnings 30 back into the compact configuration for stowing the electronic device held within cover 10 into a pocket or a bag.

In an additional aspect, the present disclosure provides for a kit of awnings 30 as described above, which are attachable directly to a portable electronic device (e.g., a cell phone, tablet or portable gaming device) or to a cover (e.g., a cover having a case body as described herein). Multiple removable awnings may be provided in a kit. The removeable awnings of the kit possess the form, fit and function of awnings 30 as disclosed herein, except that they comprise an adherent surface for attachment to the portable electronic device or cover, which is situated at a distal end of each respective awning. In various embodiments, the adherent surface may comprise an adhesive coating, hook and loop fasteners, or may be magnetized to correspond with a corresponding magnetized surface on the electronic device or cover. Once attached to the electronic device or cover, the removeable awnings can be moved between a compact configuration and a shading configuration, as discussed above. That is, each of the removeable awnings are flexible such that when attached to the portable electronic device or cover for said portable electronic device, extend from the distal end (i.e., disposed with the portable electronic device or cover) to a proximal end, and is moveable to a compact configuration in which the awnings are folded back along the portable electronic device or cover for said portable electronic device.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. A cover for a portable electronic device comprising:
a case body having a planar back defined by a sidewall; and
one or more awnings disposed along the case body such that the one or more awnings collectively and continuously span around the entire perimeter of the case body, wherein the awnings extend from and are movably engaged to the case body,
wherein the portable electronic device is receivable within case body.

2. A cover according to claim 1, wherein the cover comprises two or four awnings.

3. A cover according to claim 1, wherein each awning is positioned at a corner of the case body, such that each awning spans across two adjacent sides of the case body, preferably wherein each awning is positioned at a corner of the case body and spans between a longitudinal side of the sidewall and an adjacently positioned latitudinal side of the sidewall, preferably wherein each awning is positioned at a corner of the case body and spans between a midpoint of a longitudinal side of the sidewall and a midpoint of an adjacently positioned latitudinal side of the sidewall.

4. A cover according to claim 1, wherein each awning is disposed with the case body at a distal end of each respective awning, such that said distal end extends continuously along the perimeter between two adjacent sides of the case body, preferably wherein each awning is disposed with the case body at a distal end of each respective awning, such that said distal end extends continuously between a longitudinal side of the sidewall and an adjacently positioned latitudinal side of the sidewall, preferably wherein each awning is disposed with the case body at a distal end of each respective awning, such that said distal end between a midpoint of a longitudinal side of the sidewall and a midpoint of an adjacently positioned latitudinal side of the sidewall.

5. A cover according to claim 1, wherein each awning comprises a proximal end extending away from the distal end and defines a curved surface corresponding to a portion of the perimeter of the case body to which the respective awning is disposed.

6. A cover according to claim 1, wherein the cover is movable between a shading configuration in which the awnings extend from a distal end disposed with the case body to a proximal end away from the case body, and a compact configuration in which the awnings are folded back along a back surface of the case body.

7. A cover according to claim 1, wherein the back, the sidewall, and/or the one or more awnings are comprised entirely or partially from a thermally insulative material.

8. A cover according to claim 1, wherein the back, the sidewall, and/or the one or more of awnings are comprised entirely or partially of polystyrene, polyurethane (e.g., thermoplastic polyurethane), neoprene, silicone, rubber, nylon, acrylonitrile butadiene styrene, acetates, acrylates, ceramics, fiberglass, epoxies, polyethylene glycol, polyvinylchloride, polycarbonate, or composites thereof.

9. A cover according to claim 1, wherein the back, the sidewall and or the plurality of awnings are comprised entirely or partially of silicone.

10. A cover according to claim 1, wherein the back and the sidewall are resiliently connected to one another.

11. A cover according to claim 1, wherein the sidewall includes an opening to allow passage of a peripheral wire and/or charge cord.

12. A cover according to claim 1, wherein the back comprises an aperture corresponding to the position of a camera on a mobile electronic device.

13. A cover according to claim 13, further comprising a flap to be received within and/or cover over the perimeter of the aperture.

14. A cover according to claim 1, wherein the case body is sized to receive an electronic device containing a screen within the space defined by the sidewalls.

15. A cover according to claim 1, wherein the electronic device is one or more of a mobile phone, a tablet, a portable gaming device, or a monitor.

16. A cover for providing shade and thermal insulation to a portable electronic device comprising:
a case body comprising a planar back having a size suitable for accommodating the electronic device, the planar back further having a shape defined by a sidewall; and
four awnings disposed with the case body at a distal end of each respective awning, such that said distal end extends continuously along the perimeter between two adjacent sides of the case body, wherein the awnings extend from and are movably engaged to the case body, and wherein said awnings span continuously and entirely around a perimeter of the case body,
wherein the portable electronic device is receivable within case body, and
wherein the back, the sidewall, and/or the awnings are comprised entirely or partially of a thermally insulative material selected from polystyrene, polyurethane, neoprene, silicone, rubber, nylon, acrylonitrile butadiene styrene, acetates, acrylates, ceramics, fiberglass, epoxies, polyethylene glycol, polyvinylchloride, polycarbonate, or composites thereof.

17. A cover according to claim 16, wherein the cover is movable between a shading configuration in which the awnings extend from the distal end disposed with the case body to a proximal end away from the case body and a compact configuration in which the awnings are folded back along a back surface of the case body.

18. A cover according to claim 17, wherein the sidewall includes an opening to allow passage of a peripheral wire and/or charge cord, and wherein the back comprises an aperture corresponding to the position of a camera on a mobile electronic device.

19. A cover according to claim 17, wherein the electronic device is one or more of a mobile phone, a tablet, a portable gaming device, or a monitor.

20. A kit for a covering system for a portable electronic device comprising:
at least one awning which is attachable to a portable electronic device or a cover for said portable electronic device,
wherein each of the at least one awning includes an adhesive surface to allow for disposal along a surface of the portable electronic device or the cover for said portable electronic device, and
wherein once attached to the electronic device or the cover for said portable electronic device the one or more awnings extend from and are movably engaged to the case body.
